(19) United States
(12) Patent Application Publication
(10) Pub. No.: US 2015/0343385 A1
(43) Pub. Date: Dec. 3, 2015

(54) FLAT FILTRATION MODULE

(71) Applicant: GENERAL ELECTRIC COMPANY, Schenectady, NY (US)

(72) Inventor: Dean David MARSCHKE, Minnetonka, MN (US)

(73) Assignee: GENERAL ELECTRIC COMPANY, Schenectady, NY (US)

(21) Appl. No.: 14/651,700

(22) PCT Filed: Dec. 14, 2012
(86) PCT No.: PCT/US12/69776

§ 371 Date: Jun. 12, 2015

(51) Int. Cl. B01D 63/08; B32B 37/10; B32B 37/12; B32B 37/20

(52) U.S. Cl. CPC B01D 63/082; B32B 37/20; B32B 37/10; B32B 37/12; B01D 2313/04; B01D 2313/14; B01D 2319/025; B32B 2307/726

(57) ABSTRACT

Membranes are arranged in a stack with flat sheets of feed channel spacer and permeate carrier. Flat feed channels and permeate channels alternate through the thickness of the stack. Edges of the feed channels are sealed along the length of the stack. Edges of the permeate channels are sealed across the width of the stack. The stack may be more than 1.5 m long. Optionally, membranes may be sealed to each other without being folded. A filtration element comprises a stack and a shell. The shell has at least an inlet to the feed channels and a permeate outlet. Optionally, the element may be operated in a permeate side cross flow configuration. Parts of the stack may be pre-assembled, in some cases by an automated process. The filtration element may be used for reverse osmosis, forward osmosis, pressure retarded osmosis or nanofiltration.

### FIELD

This specification relates to membrane filtration modules, for example reverse osmosis or nanofiltration modules, in which flat membrane sheets are arranged in a stack in a module, and to methods of making them.

### BACKGROUND

Flat sheet membranes have been used in immersed ultrafiltration or microfiltration modules. In modules produced by Kubota, membrane sheets are provided on both sides of a plastic frame to form a hollow pocket. The pockets are placed in a spaced apart arrangement in a module and immersed in an open tank. Permeate is withdrawn by suction applied through a port in the frame to the inside of the pocket. In a module described in U.S. Pat. No. 7,892,430, filter elements are made up of two membrane sheets provided on both sides of a drainage element. The elements are arranged in a spaced apart relationship and immersed in an open tank. Permeate is withdrawn by suction through a pipe that passes through bores in the elements. Operating immersed in a tank of feed water and at low transmembrane pressure differential avoids the need for these modules to be rigid or strong.

Flat sheet membranes have also been used in reverse osmosis. However, reverse osmosis membranes are typically formed into spiral wound modules. The spiral wound configuration is inherently suited to high pressure applications but only when there is no cross flow on the permeate side. Attempts to make flat sheet pressure driven modules, some with cross flow, are described in U.S. Pat. No. 5,104,532, U.S. Pat. No. 5,681,464, U.S. Pat. No. 6,524,478, European Patent 1355730 and Japanese publication 7068137.

### SUMMARY OF INVENTION

The following section is intended to introduce the reader to the detailed description to follow and not to limit or define the claims.

This specification describes a stack comprising flat sheet membranes. The membranes are arranged in a stack with flat sheets of feed channel spacer and permeate carrier. The stack has planar feed channels and permeate channels alternating through the thickness of the stack. Edges of the feed channels are sealed along the length of the stack. Edges of the permeate channels are sealed along the width of the stack. In an embodiment, the length of the stack is greater than its width. The stack may also be more than 1.5 m long. Optionally, membrane sheets may be sealed to each other where required without being folded.

The specification also describes a filtration element. The element comprises a stack as described above and a shell. The shell has an inlet at one end in communication with the feed channels. The shell has at least one permeate outlet in communication with the permeate channels. The permeate outlet may further communicate with a permeate conduit along the length of the stack or perpendicular to the sheets of the stack. Optionally, the element may have a permeate inlet and an outlet such that the element may be operated in a cross flow configuration. The element may be used, for example, for reverse osmosis, forward osmosis, pressure retarded osmosis or nanofiltration.

This specification also describes methods of making a stack. Parts of the stack may be pre-assembled, optionally by way of a substantially continuous or automated process.

### BRIEF DESCRIPTION OF THE FIGURES

FIG. 1 is an exploded isometric view of an assembly of sheets forming a stack.

FIG. 2 is an isometric view of an element including the stack of FIG. 1.

FIG. 3 is a cross section of the element of FIG. 2 along line 3-3 of FIG. 2.

FIG. 4 is a cross section of the element of FIG. 2 along line 4-4 of FIG. 2.

FIG. 5 is an isometric view of a second stack.

FIG. 6 is an exploded cross section of a second element including the second stack of FIG. 5.

FIG. 7 is an assemble cross section of the second element.

FIG. 8 is an exploded isometric view of a third stack during a step in an assembly process.

FIG. 9 is a cross section of a third element having the third stack of FIG. 8 during a step in an assembly process.

FIG. 10 is a plan view of the third element of FIG. 9.

FIG. 11 is a schematic drawing of a machine for making a stack or a portion of a stack.

FIG. 12 is a schematic drawing of a machine for making permeate holes in a stack or a portion of a stack.

FIG. 13 is a plan view of a permeate carrier having a reinforced permeate holes.

FIG. 14 is a plan view of a feed spacer having a permeate hole reinforced with a ring and pre-applied edge seals.

FIG. 15 is a schematic drawing of a device for setting the thickness of the ring of FIG. 14.

### DETAILED DESCRIPTION

Most reverse osmosis modules are made in a spiral wound configuration. In a typical module, the feed flows along the length of the module. Membranes are used in the form of a folded sheet with the fold abutting a permeate collection tube. The length of the feed path is limited by the width of the membrane material which is typically less than 1.5 meters. The length of the sheet is limited by resistance to permeate flow, which would limit the efficiency of the modules. Glue lines are applied to the membranes or permeate carriers with large tolerances for movement of the layers as they are wound up. In combination, these procedures result in the active membrane surface area in a spiral wound module being significantly less than the surface area of the membrane material consumed in manufacturing the module.

In place of a leaf in a spiral wound module, a flat filtration module as described in this specification may be made from a stack of materials that remain flat in the finished material. Optionally, the stack may be assembled from pre-made clips comprising a permeate carrier, a feed spacer, and two membranes. The two membranes may be formed by folding a single piece of membrane material or from two separate pieces of membrane material. Two membranes can be bonded to each other in the stack for example by ultrasonic or thermal welding, adhesives such as hot melt glues or urethane resin, or by tape. The bonded membranes create barriers between a feed sides and a permeate side of the module. The flat filtration module can be used, for example, for reverse osmosis or nanofiltration or as an alternative to a spiral wound membrane.

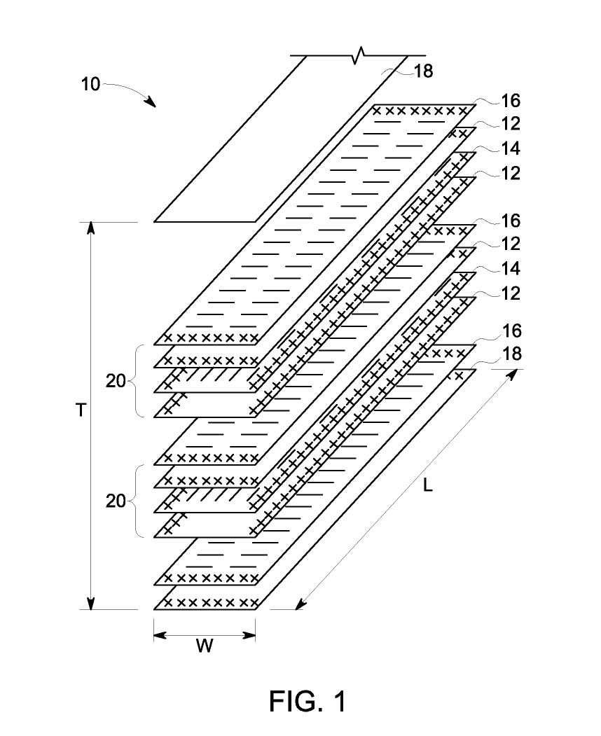

FIG. 1 shows a stack 10. The stack 10 is composed of flat layers of materials. Optionally, a sheet of material may be folded, across its length or its width, to form multiple layers. The individual layers are: membrane 12, feed spacer 14, permeate carrier 16 and, optionally, barrier sheet 18. The barrier sheet 18 is an impervious layer, for example a polyethylene sheet. Optionally, the barrier sheet 18 may be replaced by a shell of a module.

A sub-assembly comprising two sheets of membrane 12, a feed spacer 14 and a permeate carrier 16 will be referred to as a clip 20. In the clip 20, the two membranes 12 are spaced apart by one of the feed spacer 14 and the permeate carrier 16, and the other of the feed spacer 14 and the permeate carrier 16 is on the outside of the clip 20. The separation layers of the membranes 12 face the feed spacer 14. The clip 20 shown is ordered, starting from the bottom of the clip 20 as first membrane 12, feed spacer 14, second membrane 12, and permeate carrier 16. However, the clip 20 could alternatively start with the feed spacer 14, the second membrane 12 or the permeate carrier 16. When multiple clips 20 are stacked on top of each other, successive membranes 12 are spaced apart by alternating layers of feed spacer 14 and permeate carrier 16. Optionally, there may be additional layers that do not form a complete clip 20 at the top or bottom, or both, of the stack 10. A stack 10 may have one clip 20 or a plurality of clips 20. Multiple clips 20 may be pre-assembled and the stacked as clips 20 to form the stack 10.

The layers of material in the stack 10 may be the same materials used in making spiral wound membranes. For example, the membrane 12 may be a thin film composite reverse osmosis or nanofiltration membrane cast on a supporting structure. The feed spacer 14 may be an expanded plastic mesh. The permeate carrier 16 may be a tricot knit fabric.

For the purposes of this specification, the stack 10 will be described with reference dimensions as shown in FIG. 1. The longer dimension of the sheets of material will be referred to as a length L. The shorter dimension of the sheets of material will be referred to as the width W. The dimension perpendicular to the plane of the material will be referred to as thickness T. The stack 10 is not limited in length L to the width of typical membrane materials and may be longer than 1.5 meters. A long stack 10 has fewer seals perpendicular to the length L of the stack 10 per unit area and so may achieve a higher effective filtration area per unit area of membrane 12. A long stack 10 can also avoid the anti-telescoping devices, O-rings, module interconnectors and other parts that are required to create between modules in a chain of spiral wound modules of similar length.

Still referring to FIG. 1, a line of X marks (i.e. XXXXXXXXX) on a layer indicates a seal between the two membranes 12 on either side of the seal. The seal may be made directly between the membranes 12, through an intermediate layer, or by seals from both membranes 12 to the intermediate layer. The membranes 12 above and below a feed spacer 14 are sealed along the length of the feed spacer 14. The membranes 12 above and below a permeate carrier 16 are sealed along the width of the permeate carrier 16. A membrane 12 separated from a barrier sheet 18 by a feed spacer 14 or permeate carrier 16 adjacent to a barrier sheet 18 is sealed to the barrier sheet 18, directly, through the intermediate layer, or by a seal to the intermediate layer which is sealed to the barrier sheet 18. The feed spacers 14 and associated seals form generally flat feed channels open at the ends of the stack 10 and running through the length of the stack 10. The permeate carriers 16 and associated seals form generally flat permeate channels closed at the ends of the stack 10. The permeate channels may be open on both sides of the stack 10, be open on one side of the stack 10, or be closed on all four sides of the stack 10.

Seals may be made by any method known for making a spiral wound membrane. For example, a seal may be a fold in a sheet of material or made by a sealant. Suitable sealants include urethanes, epoxies, silicones, acrylates and hot melt adhesives. For example, seals may be made with ethylene vinyl acetate (EVA) based hot melt adhesive. Seals made with sealants are cured after or while the stack 10 is compressed according to an embodiment. However, unlike spiral wound membranes modules, the stack 10 may be assembled without requiring sheets of material to slide against each other while a sealant is curing. A seal may therefore be made by methods that would bond too quickly for use in making spiral wound modules. For example, seals may be made by thermal, laser welding or ultrasonic welding, or by a fast setting sealant. Alternatively, a seal may be made by a line of tape joining two membranes 12 together around a feed spacer 14 or permeate carrier 16.

In an embodiment, the seals are sized and placed as close to the edge of the stack as possible while still being strong enough to resist a design pressure. Movement of the layers during rolling does not need to be accommodated and so, relative to a spiral wound module, a higher percentage of the membrane source material may become active membrane area in the stack 10. Longer element lengths allow for a higher active membrane area as a percentage of the membrane material used. Seals that cure faster can be placed more precisely, thereby reducing the need for wide seals and further increasing active membrane area. Movement of the layers can be controlled precisely in a web based process, which also helps reduce the need for wide seals.

In FIG. 1, a feed spacer 14 is sealed along its edges in length to the membranes 12 above and below it. Optionally, two membranes 12 may be sealed to each directly beside the edges of the feed spacer 14. In this case, the width of the feed spacer 14 is less than the width of the membranes 12. The edges of the membranes 12 are drawn together and attached, for example by a sealant or sonic or thermal welding. The feed spacer 14 does not need to be included in the seal. However, the feed spacer 14 may optionally protrude at least partially into the seal to inhibit movement of the feed spacer 14. This may allow for a higher cross flow velocity or feed pressure to be applied to the stack 10. In FIG. 1, a permeate carrier 16 is also sealed along its edges in width to the membranes 12 above and below it. As described for the feed spacer 14, two membranes 12 may be sealed to each other beside the edge of the permeate carrier 16.

A sub-assembly of two membranes 12 with a feed spacer 14 sealed between them may be made essentially continuously by unrolling these three layers through an edge sealing device. The sub-assembly can be cut into segments after passing through the edge sealing device to create segments for use in building clips 20 and stacks 10. Optionally, a permeate carrier 16 may be rolled out over the upper membrane 12 to create a clip 20 as shown in FIG. 1 before the layers are cut into segments. Dots of sealant or spot welds can be used to prevent the permeate carrier 16 from sliding relative to the membrane 12.

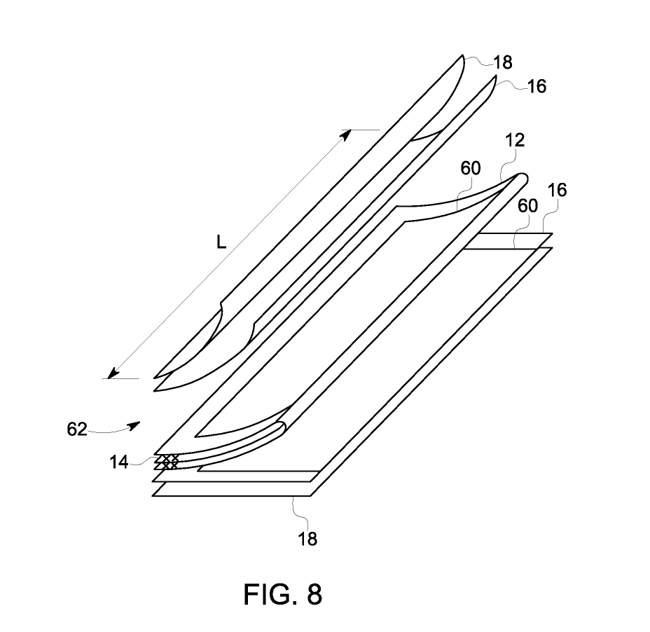

With or without the clips 20 pre-made in this way, the stack 10 is assembled by applying sealant to the permeate carrier 16 of a clip 20 and placing another clip 20 on top, repeating these steps until a desired stack 10 height is reached. Barrier layers 18 and a lower permeate carrier 16 with associated lines of sealant may be added as shown in FIG. 1 but are not necessarily required. Sealant may be applied to the permeate carrier 16 in two lines as shown in FIG. 1 to create a permeate-side cross flow stack. Alternatively, sealant may be applied to the permeate carrier 16 in a three sided pattern (similar to glue lines 60 in FIG. 8) to provide a stack in which permeate is withdrawn from one edge only. In an embodiment, the stack 10 is compressed between two flat plates while the glue cures.

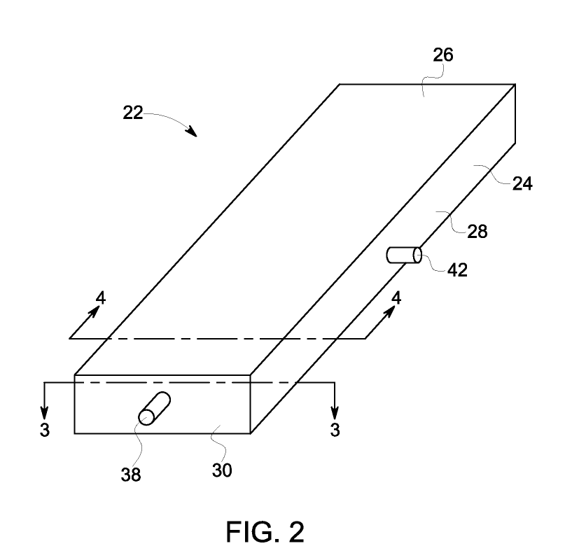

FIG. 2 shows a filtering element 22, alternatively called a module. The element 22 has a shell 24 surrounding a stack 10. In an embodiment, the shell 24 is rigid and able to withstand feed water pressure applied to the stack 10 with minimal deflection. The shell 24 is non-porous and may be made, for example, from a plastic such as ABS, or stainless steel. The shell 24 shown is made from two top panels 26, two side panels 28 and two end panels 30. The top panels 26 may alternatively be called a top panel 26 and a bottom panel 26 when referring to a specific one of them. The panels 26, 28, 30 may be glued or welded together. However, other shapes and methods of construction may be used. The shell 24, particularly the top panels 26, may be shaped so as to increase its effective thickness and reduce deformation.

Referring particularly to FIG. 4, the stack 10 is shown with only a few layers spaced apart for ease of illustration only. However, when assembled the layers of a stack 10 are placed directly on top of each other. The top and bottom layers of the stack bear against the top panels 26 of the shell 24 at least in use. In this way, the top panels 26 prevent the stack 10 from expanding to an extent that would damage the seals when feed water is applied under pressure to the stack 10. Optionally, the top panels 26 may be sealed to the stack 10.

The panels 26, 28, 30 are attached and sealed to each other to make the shell 24, for example by adhesive or ultrasonic welding. In one assembly procedure, the shell 24 is made but for one of the top panels 26. A stack 10 is placed in the shell 24 and optionally sealed to the bottom panel 26. The corner seals 32 are cast in place. The remaining top panel 26 is attached, and optionally sealed to the stack 10, while the corner seals 32 are curing. In another assembly procedure, the shell 24 is assembled but for one of the side panels 28. The stack 10 is inserted into the shell 24. The corners seals 32 are injected into the shell 24. Optionally, the exterior of the corners of the shell 24 may be formed by the corners seals 32. In any of these options, the side panels 28 and end panels 30 may be sized such that the top panels 26 compress the stack 20.

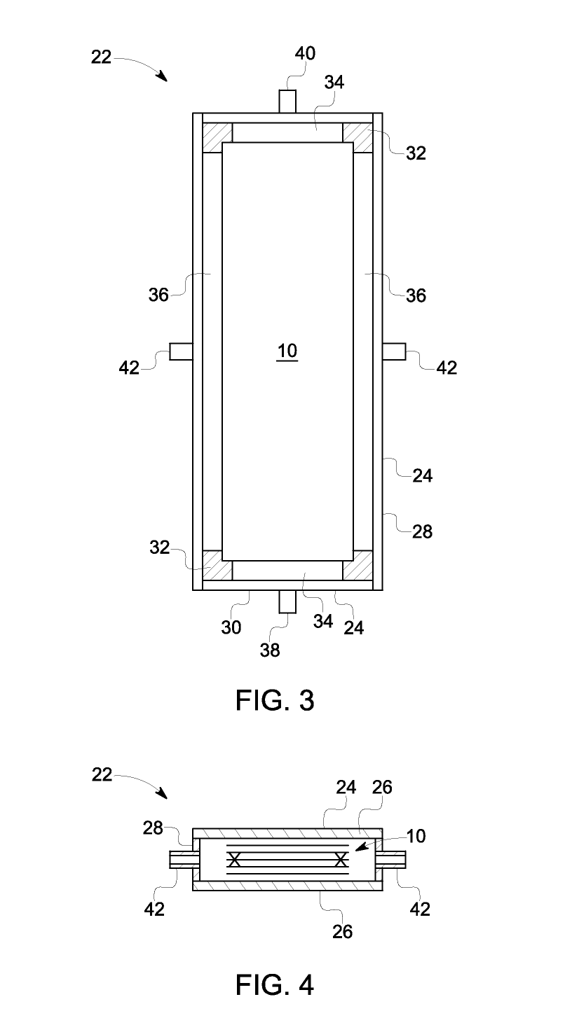

Referring particularly to FIG. 3, corner seals 32 separate the interior of the shell around the stack 10 into one or more end compartments 34 and, optionally, into one or more side compartments 36. The corners seals 32 seal to the shell 24 and to the stack 10. The corner seals 32 may be made, for example, of a sealant such as hot melt glue, epoxy or urethane. Each end compartment 34 is in fluid communication with the feed spacers 14. Each side compartment 36, if any, is in fluid communication with the permeate carriers 16.

A feed port 38 is provided in one end panel 30 to connect a source of feed water to the element 22. Optionally, a retentate port 40 may be provided in the other end panel 30 to remove retentate, alternatively called concentrate or brine. In another option, feed can be provided from ports 38, 40 on both ends of the element 22. A permeate port 42 is provided for each side compartment 36 to remove permeate from the element 22.

Although side compartments 36 are optional, having side compartments 36 on both sides of the permeate carrier 16 allows for a reduced permeate path length per unit width W of the stack 10. This can result in an increased net filtration pressure relative to a module with one side compartment 36. Alternatively, an element 22 with two side compartments 36 may be used with cross flow on the permeate side of the element 22.

An element 22 can be built around a stack 10 of essentially any thickness T. Side panels 28 and end panels 30 need to be stronger with increasing thickness T, but the number of top panels 22 per unit membrane area is reduced with increasing thickness T. The thickness T can be chosen to optimize material consumed by the shell 24. Alternatively, a lesser thickness T may be chosen to allow for more easily scalable systems and to provide smaller individual elements 22 for replacement or repair.

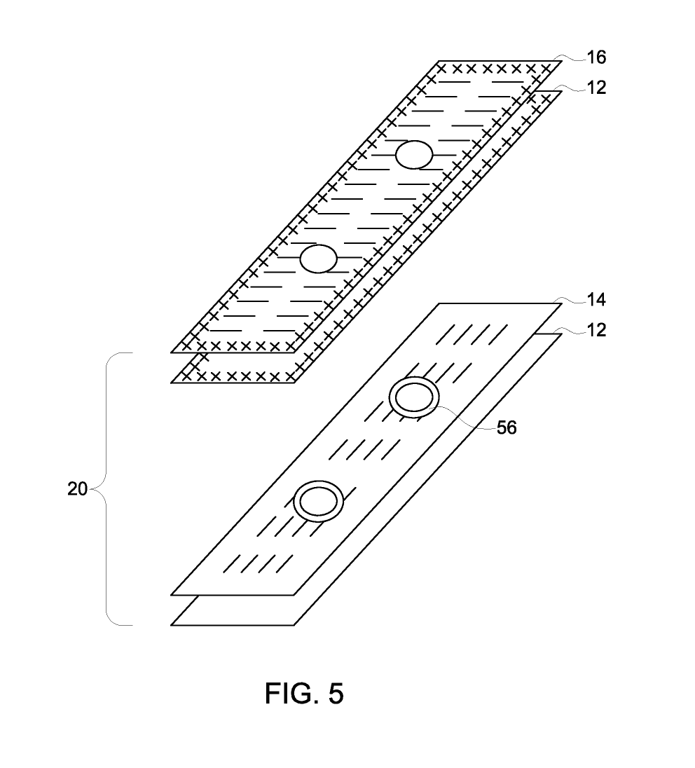

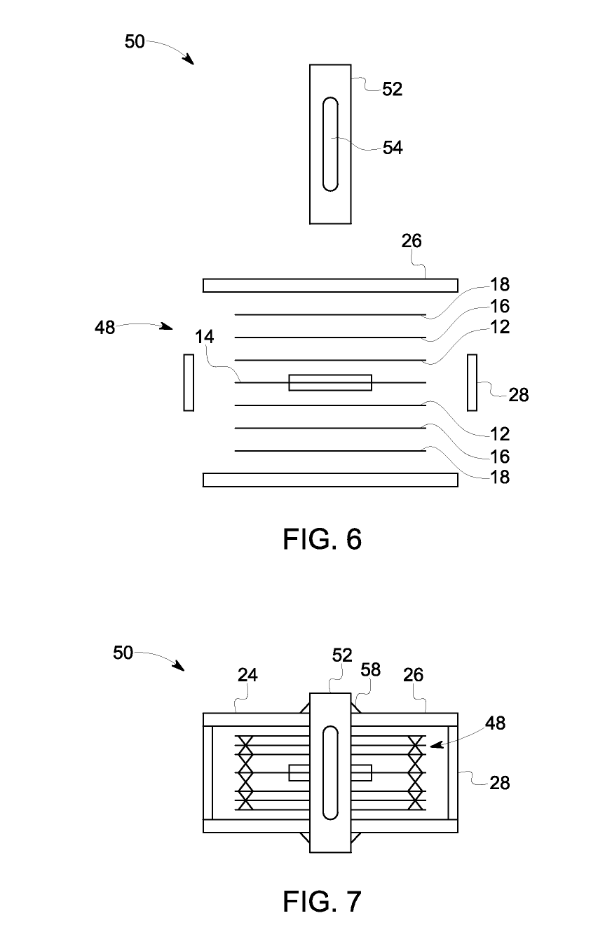

FIGS. 5 to 7 show a second element 50. The second element 50 is similar to the element 22 but the second element 50 is essentially without side compartments 36. Instead, permeate is removed through a spigot 52 that passes through holes in the stack 10 and the top panels 26. The spigot 54 has one or more openings 54 to collect permeate from within a second stack 48. Feed water is kept from entering the spigot 54 by rings 56 around holes in the feed spacer 14. The thickness of the rings 56 is exaggerated in FIG. 6. The rings 56 pass through the feeds spacer 14 and are at least thick enough to be compressed against the adjacent membranes 12 when the second stack 48 is in the shell 24.

The rings 56 may be made, for example, of a pre-made elastomeric material placed within a hole in the feed spacer 14. Alternatively, the rings 56 may be made of a curable sealant, for example hot melt adhesive, cast in place with part of the feed spacer embedded in the ring 56. The stack 10 may be assembled before the sealant cures such that it binds to the adjacent membranes 12. Alternatively, the sealant may be pre-cured. With a ring 56 made of an elastomeric material or pre-cured sealant, when the stack 10 is assembled additional sealant can be applied between the ring 56 and the adjacent membranes 12 or the ring 56 may be re-heated after the membranes 12 have been added to seal the ring 56 to the membranes 12. Seals along the edges of the feed spacer 14 may be made in similar ways, for example with strips sealed to the membranes as described for the rings 56. The spigot 52 is sealed to the shell 24, for example with glue 58.

Membranes 12 on either side of a permeate carrier 16 are typically sealed together on all four edges since permeate is withdrawn from the spigots 52. In this case, the permeate side of the second element 50 is separated from the feed side but corner seals 32 may still be used on at least one end of the second element 50 to prevent the feed water from by-passing the feed spacer 14. The second stack 48 does not need to be sealed to the shell 24 or barrier layers 18. The second stack 48 may have feed spacer 14 as its first and last layer. Alternatively, one or more additional corner seals 32 may be use and one or more edges of the permeate carrier 16 may be left open to also collect permeate from one or two side compartments 36 as in FIGS. 2 to 4.

FIG. 8 shows part of a process for making a third stack 62. In the third stack 62, two layers of membrane 12 are provided, and one seal is formed, by folding a sheet or membrane material around a feed spacer 14. Glue lines 60 are made using a sealant, such as hot melt adhesive, of a type used in making spiral wound membranes. The glue lines 60 are laid out in the pattern that is visible on the upper membrane 12 in FIG. 8. However, the glue lines 60 may be laid out on either the permeate spacer 16 or the membrane sheet 12 of each set of permeate spacer 16 and adjacent membranes sheet 12. After all of the layers in the third stack 62 have been assembled, the stack is compressed which forces the glue lines to penetrate through the permeate spacers 16. The glue is allowed to cure while the third stack 62 is under compression. In this way, membranes 12, or pairs of a membrane 12 and a barrier layer 18, that are separated by a permeate spacer 16 are sealed to each other.

To help align the layers of the third stack 62 during assembly, the length L of one edge of the third stack 62 may be clamped while the glue lines 60 are applied. Alternatively, that edge of the third stack 62 may be ultrasonically welded, which may also avoid the need to apply the portion of the glue lines 60 that would be parallel to the weld. Upper layers of the third stack 62 are initially folded back over the clamp or weld until any required glue lines 60 have been applied to lower layers.

The third stack 62 may be installed in a shell 24 as shown in FIGS. 2 to 4 except that only one side compartment 36 and permeate port 42 are used. The third stack 62 releases permeate only along its length at the right side of the third stack 62 as it is oriented in FIG. 8. The feed spacer 14 also needs to be sealed to the adjacent membranes 12 along the left side of the third stack 62 (as it is oriented in FIG. 8). This seal may have been accomplished by welding through the entire left side of the third stack. Alternatively, the feed spacer 14 may have a sealant along its left side that forms a seal in any of the ways described for the rings 56 or edge pre-seal 114 in FIGS. 5-7 and 14.

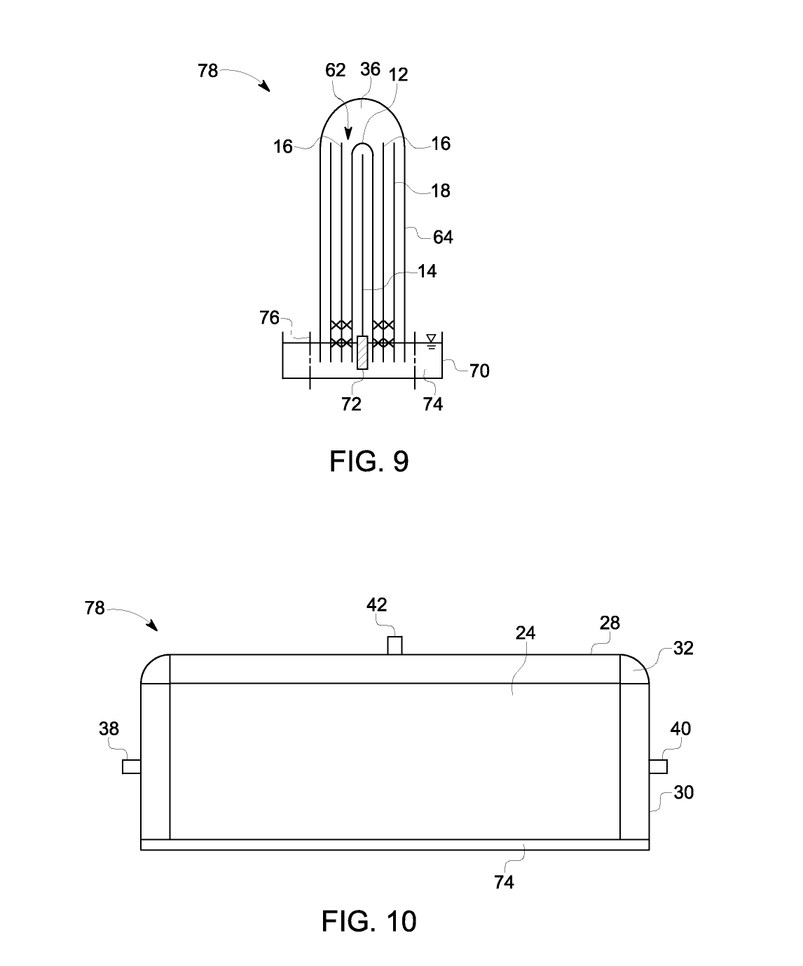

As another alternative, the left side of the feed spacer 14 may be sealed by potting after the third stack 62 is assembled as shown in FIG. 9. In FIG. 9, the third stack 62 is inserted into the edge of a second shell 64. The second shell 64 has a sheet forming the equivalent of two top panels 26 and a side panel 28. A side compartment 36 is defined by a generally semi-circular curved portion of the second shell 64. Additional curved sheets, shown in FIG. 10, provide the equivalent of end panels 30. The curved parts of the second shell 64 allow it to be expanded to insert the third stack 62. Two corner seals 32, also visible in FIG. 10, are cast in placed after the third stack 62 is inserted and join the corners of the curved sections. Any excess material in the third stack 62 protruding from the second shell 64 may be trimmed to be flush with, or at a desired distance from, the edge of the second shell 64.

Potting the feed spacer 14 seals the membranes 12 to the feed spacer 14 and forms the equivalent of a second side panel 28 and two more corner seals 32. To pot the feed spacer 14, the assembly described above is inserted into a pan 70 containing liquid potting resin 74. Optionally, potting resin 74 may be prevented from flowing far into the feed spacer 14 by a blocking strip 72. The blocking strip 72 shown in FIG. 9 protrudes from the stack 10, but the blocking strip 72 may alternatively be recessed within the stack 10 to allow some potting resin 74 to penetrate into the stack 10. The blocking strip 72 may be made by pre-curing a sealant such as a hot melt adhesive in the feed spacer 14. Alternatively, a viscous potting resin 74 may be drawn into the feed spacer by omitting the blocking strip 72 and applying a vacuum to the feed port 38 or retentate port 40. After the potting resin 74 cures into a solid, the assembly, now forming a fourth element 78, is withdrawn from the pan 70. Optionally, the resin block may be cut along trim lines 76. FIG. 10 shows a completed fourth element 78.

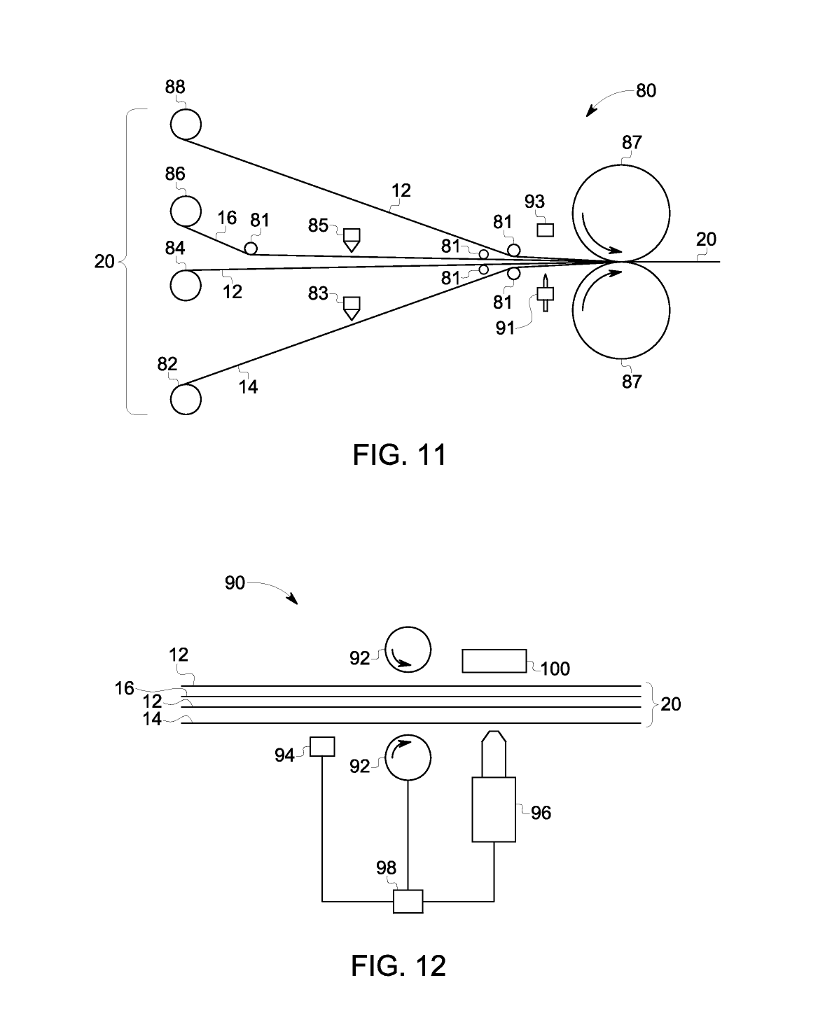

FIG. 11 shows a system 80 for assembling a clip 20 in a generally continuous manner. The clip 20 can be made in any length and later cut into segments for making a stack 10, 48, 62. The clip 20 in this example has, starting from the bottom, a feed spacer 14, a membrane 12, a permeate carrier 16 and another membrane 12. Optionally, part of the clip comprising a membrane 12, a permeate carrier 16 and another membrane 12 may be made in the system 80 with the feed spacer 14 added later when assembling a stack 10, 48, 62. In another option, part of the clip 20 comprising a membrane 12, a feed spacer 14, and another membrane 12 may be made in the system 80 (the order of layers is changed relative to FIG. 11) with the permeate carrier 16 added later when assembling a stack 10, 48, 62.

Each of the layers is fed from a roll. In the example of FIG. 11, a feed spacer roll 82 is located below a first membrane roll 84 which is below a permeate carrier roll 86 which is below a second membrane roll 88. The layers may pass over various idler rolls 81. The idler rolls 81 may position a layer as required for a tool (to be described below) to operate on the layer. The idler rolls 81 also align the layers for feeding into a pair of nip rollers 87. The nip rollers 87 compress sealant applied to the layers to cause the sealant to penetrate through one or more of a feed spacer 14, permeate carrier 16 or the support layer of a membrane 12. One or both of the nip rollers 87 may be made of, or covered with, an elastomeric material such as rubber or silicone. The elastomeric material helps the nip rollers 87 take in the layers with beads of sealant and yet produce a clip 20 compressed to about the sum of the thickness of the layers.

The nip rollers 87 also flatten the resulting clip 20 in the direction of the length of the nip rollers 87. One or both of the nip rollers 87 may be heated to help the sealant flow during a short residence time in the nip. Sealants of the type used in making spiral wound membranes may be used, but, in an embodiment, with formulations that are less viscous and faster setting.

Sealant is applied to the permeate carrier 16 from one or more nozzles 85. A nozzle 85 may be suspended on a servo controlled table such that the nozzle 85 can be moved across and along the permeate carrier 16. For example, to produce a line of sealant across the width of the permeate carrier 16, the nozzle 85 moves across the permeate carrier 16 while also moving towards the nip rollers 87 at the same speed as the permeate carrier 16. To produce a line of sealant along the edge of the permeate carrier 16, the nozzle 85 stays in position relative to the width of the permeate carrier 16 but retracts away from the nip rollers 87 to be ready to make another line across the width of the permeate carrier 16. By combining these movements with turning a metering pump supplying sealant on and off, the nozzle 85 can produce various patterns on the permeate carrier. For example, the nozzle 85 can produce parallel lines of sealant as shown in FIG. 1, a three sided pattern as shown in FIG. 8 or a four sided pattern as shown in FIG. 6.

Optional nozzle 83 applies sealant to the feed spacer 14. For example, dots of sealant may be applied to keep the feed spacer 14 relative to the other layers. In this case, full lines of sealant are applied to the feed spacer 14 when clips 20 are assembled into a stack. Alternatively, nozzle 83 may apply full lines of sealant along the edges of the feed spacer as shown in FIG. 1. In this case, the sealant may be a hot thermoplastic sealant reactivated by applying heat to a stack 10 of clips 20 to seal adjacent clips 20 together, or additional sealant may be applied while assembling the stack 10. A temporary barrier sheet 18 may be unrolled under the feed spacer 14 if required to prevent sealant from being deposited on the lower nip roller 87. Alternatively, feed spacer 14 maybe rolled out between two membranes 12. The nozzle 83, or another specialized nozzle, may also be used to apply rings 56 as shown in FIGS. 5 to 7 to the feed spacer 14.

In a case where the system 80 is used to create a second element 50 as in FIGS. 5 to 7, the four sided sealant pattern on the permeate carrier 16 can capture a pocket of excess air between membranes 12. This may prevent the layers from being compressed together. The nip rollers 87 inhibit this problem by squeezing out excess air as the layers advance. However, since holes will be punched for the spigots 52 in any event, a hole can be punched through the membranes 12 before the membranes 12 are compressed around the permeate carrier 16 to provide another path for air to escape. In the system 80, holes are punched by a block 93 and die 91 upstream of the nip rollers 87. The die 91 is actuated at a frequency that, given the line speed of the system 80, produces holes at the spacing of the spigots.

In other methods of constructing a second element 50 without using nip rollers 87, it is also helpful to perforate the membranes 12 in the area where the spigots 52 will be located before constructing a pocket of two membranes 12 sealed to a permeate carrier 16. One or more holes are only required in one membrane 12 of a packet comprising two membranes 12 sealed around a permeate carrier 16.

A hole made in the membranes 12 before sealing to the permeate carrier 16 may be the final size required to accommodate the spigot 52. However, in the system 80 the layers may be moving at a line speed that makes it difficult to punch a large hole with precision. In that case, a small hole sufficient to release air may be punched by the system 80 and a larger hole for the spigot 52 can be made later.

FIG. 12 shows a machine 90 for making larger holes for a spigot 52. A clip 20 or other assembly of layers is fed by geared rollers 92 controlled by a controller 98. The controller 98 is also connected to a sensor 94 and a punch 96. The controller 98 advances the clip 20 until the sensor 94 detects an air release hole. The controller 98 then causes the rollers 92 to advance the air release hole to a position within the area of the die 96. Optionally, the controller may stop the rollers 92 at this point while the punch 96 operates. The controller 98 instructs the punch 96 to punch a hole against block 100. However, because the air release holes may not be accurately located, the controller 98 advances the clip as required to provide a desired spacing between the spigots 52. Sensing the position of the air release hole is done to check whether the air release hole will be located within the spigot hole. If so, then the spigot hole is punched and the machine 90 goes to make the next spigot hole. If not, the controller 98 sends an alarm to indicate that part of the clip 20 is defective and resets by putting the next air release hole in the center of the punch 96. The process of putting the holes in the membranes 12 or a clip 20 could alternatively be done with a rotary die cutter. This applies to air relief holes or to spigot holes in the machine 90 or the system 80.

Machine 90 may also be used to make spigot holes when no air release holes are made by system 80. In this case, sensor 94 is omitted and machine 90 advances the clip 20 as required to produce spigot holes in desired locations. Optionally, machine 90 may also be fitted with a cutter and produce clip segments of a required length with spigot holes in specified locations.

In an optional assembly method, air release holes, spigot holes or other registration holes are used to align multiple clips 20 as they are placed on top of each other to from a stack. For example, the clips 20 can be placed over a jig having vertical pins on the centers of where the spigots 52 will be located. Once all layers are in place, the pins are withdrawn. If required, and a punch, or other hole making device, is pushed through the entire stack 10 to enlarge the holes to the size of spigot holes.

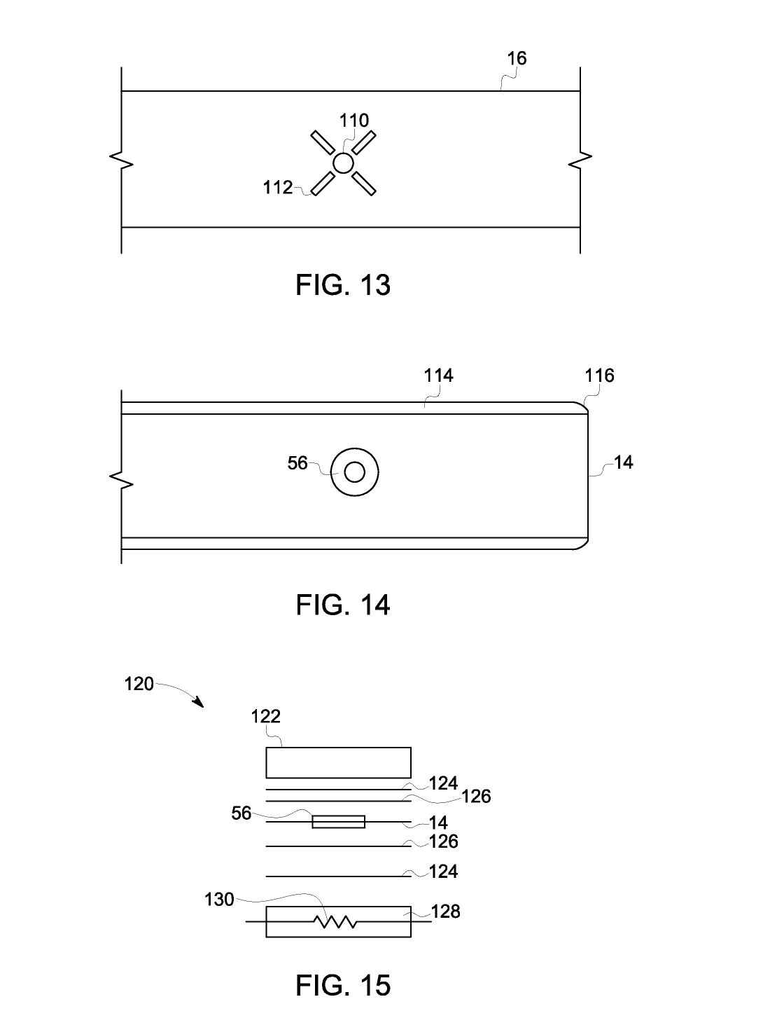

Still considering a second element 50 as in FIGS. 5 to 7, when a stack 10 is assembled there is a tendency for the rings 56 to compress the permeate carrier 16 in areas between, or above or below, the rings 56. Compressing the permeate carrier 16 increases its resistance to the flow of permeate to the spigot 52. Referring to FIG. 13, a spigot hole 110 in the permeate carrier 16 is optionally reinforced to resist compression by the rings 56. In this example, radial lines 112 of sealant, such as EVA or other hot melt adhesive, are embedded in the permeate carrier 16 around the spigot hole 110.

FIG. 14 shows an example of a feed spacer 14 pre-conditioned for assembly into a second element 50 as in FIGS. 5 to 7. The feed spacer 14 has a ring made by applying and curing a hot melt adhesive such as EVA around an air release hole, registration hole, or full sized spigot hole. Edge pre-seals 114 are applied along the length of the feed space by applying and curing a hot melt adhesive. Optionally, one or more corners of the feed spacer 14 may have a recess 116 to help a corner seal 32 attach to membranes 12 around the feed spacer 14. Similar recesses 116 may be used with other elements having corner seals 32. The feed spacer 14 is assembled into a stack 10, for example by being alternated with packets of membranes 12 pre-sealed around a permeate carrier 16. The rings 56 and edge pre-seals 114 can be sealed to adjacent membranes 12 by applying an additional sealant to the rings 56 and edge pre-seals 114 before they are pressed against membranes 12. In this case, the additional sealant may have a low viscosity and fast setting time. Alternatively, the stack 10 may be assembled without additional sealant. In this case, the stack 10 is re-heated after assembly such that the hot melt adhesive of the rings 56 and edge pre-seals 114 melt at least partially and adhere to the membranes 12.

In an embodiment, the height of the rings 56 and edge pre-seals 114 is close to the thickness of the feed spacer 14. FIG. 15 shows a press 120 used in a process of applying rings 56, edge pre-seals 114 or both. A portion of the press 120 around ring 56 is shown, but a larger press maybe used to also apply the edge pre-seals 114. The press 120 has an upper plate 122 and a lower plate 128. In an embodiment, at least one of the plates 122, 128 has a heating element 130. A feed spacer 114 with a molten hot melt adhesive is inserted between the plates 122, 128 and the plates 122, 128 are brought together to the thickness of the feed spacer 14. However, the feed spacer 14 is very thin (for example about 0.029 inches thick) and simply pressing the hot melt adhesive tends to produce a ring 56 of uneven thickness with parts that may be 30% or more thicker than the feed spacer 14. Heating at least one of the plates 122, 128 and leaving the feed spacer 14 in the press 120 for a period of time, for example 10 minutes or more, reduces the excess thickness to within a few percent of the desired thickness. Optionally, release layers 126 may be used above and below the feed spacer 14. Insulating layers 124 prevent the release layers 126 from melting to the presses 120. In the example shown, the insulating layers 124 are sheets of permeate carrier 16. The permeate carrier 16 additionally provides a path for air to escape from the press 120.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A stack, comprising:
flat sheet membranes;
one or more flat sheets of feed spacer; and,
one or more flat sheets of permeate carrier,
wherein the stack has one or more generally flat feed channels and one or more generally flat permeate channels alternating through the thickness of the stack.

2. The stack of claim 1, wherein edges of the feed channels are sealed along the length of the stack and edges of the permeate channels are sealed across the width of the stack.

3.-4. (canceled)

5. The stack of claim 1, wherein successive membrane sheets are bonded to each other but without being folded.

6. The stack of claim 1, wherein edges of the permeate channels are sealed across the width of the stack and along one side of the length of the stack.

7. The stack of claim 1, wherein the one or more flat sheets of feed spacer protrude at least partially into seals between membranes on either side of the one or more sheets of feed spacer.

8. The stack of claim 1, wherein the one or more flat sheets of feed spacer comprise pre-applied strips or rings.

9. The stack of claim 1, wherein the one or more flat sheets of feed spacer comprise pre-applied strips of sealing material recessed on two or more corners of the feed spacer.

10. (canceled)

11. The stack of claim 1, further comprising a barrier layer at the top or bottom of the stack, or both.

12. A filtration element, comprising:
a stack comprising:
flat sheet membranes;
one or more flat sheets of feed spacer; and,
one or more flat sheets of permeate carrier,
wherein the stack has one or more generally flat feed channels and one or more generally flat permeate channels alternating through the thickness of the stack;
a shell;
an inlet at one end of the shell in communication with the feed channels; and,
at least one permeate outlet in communication with the permeate channels

13. The element of claim 12, further comprising a permeate conduit along the length of the stack or perpendicular to the sheets of the stack.

14. The element of claim 12, further comprising a permeate conduit along the length of the stack formed in part by the inside of the shell.

15. The element of claim 12, further comprising a second permeate outlet.

16. The element of claim 12, further comprising an inlet in communication with the permeate channels.

17. The element of claim 12, further comprising at least two corner seals separating the feed channels from the permeate channels.

18. The element of claim 12, wherein the shell bears against the top and bottom of the stack at least when in use.

19. (canceled)

20. The element of claim 12, further comprising a resin block forming a seal between the stack and the shell.

21. (canceled)

22. A method of making a stack including flat sheet membranes, one or more flat sheets of feed spacer, and one or more flat sheets of permeate carrier, wherein the stack has one or more generally flat feed channels and one or more generally flat permeate channels alternating through the thickness of the stack, the method comprising:
pre-assembling a plurality of clips, each clip comprising two membranes and either a feed spacer or a permeate carrier, wherein the two membranes are located on either side of the feed spacer or permeate carrier and the two membranes are attached to each other.

23. The method of claim 22, wherein the clip comprises a feed spacer and the feed spacer has a pre-applied strip or ring.

24. (canceled)

25. The method of claim 22, wherein the clip comprises a permeate carrier and the two membranes are located on either side of the permeate carrier.

26. (canceled)

27. The method of claim 22, further comprising:
feeding the materials in the clip from rolls;
applying a sealant to one or more of the materials; and
compressing the materials together.

28.-34. (canceled)
